(19) United States
(12) Patent Application Publication
(10) Pub. No.: US 2010/0001835 A1
(43) Pub. Date: Jan. 7, 2010

(54) Customer Paging and Communications System

(76) Inventors: Shawn P. Haley, Lake Orion, MI (US); John P. Manfreda, Sterling Heights, MI (US); Mark J. Woloszyk, Sterling Heights, MI (US); Robert M. Ford, Troy, MI (US)

Correspondence Address: REISING ETHINGTON P.C., P O BOX 4390, TROY, MI, 48099-4390, US

(21) Appl. No.: 12/496,318

(22) Filed: Jul. 1, 2009

Related U.S. Application Data
(60) Provisional application No. 61/077,274, filed on Jul. 1, 2008.

(51) Int. Cl. H04Q 1/30

(52) U.S. Cl. 340/7.55

(57) ABSTRACT

A customer paging and communications system comprising a base unit and a plurality of pagers. The base unit may include an input interface and a base unit processor that's configured to receive pager identifiers and then generate alert signals associated with the respective pager identifiers. The base unit may also include a base unit transmitter that transmits the pager identifiers, an informational message, and an alert signal to the pagers. Each of the pagers may be identified with a corresponding one of the pager identifiers and may comprise a pager receiver and pager processor configured to receive the corresponding pager identifier, an informational message, and an alert signal from the base unit. Each pager processor may be configured to generate an alert if a received alert signal is associated with the pager identifier associated with that particular pager. Each pager may also include a display that may be configured to display the informational message received from the base unit. The base unit may be further configured to stream information to the plurality of pagers and each pager may be further configured to display the streamed information.

### CROSS-REFERENCES TO RELATED APPLICATIONS

This application claims priority in, and incorporates by reference in its entirety, U.S. Provisional Patent Application Ser. No. 61/077,274 filed 1 Jul. 2008.

### STATEMENT REGARDING FEDERALLY SPONSORED RESEARCH OR DEVELOPMENT

Not Applicable

### BACKGROUND OF THE INVENTION

1. Field of the Invention

This invention relates generally to customer paging and communications systems for notifying customers when a desired service is available.

2. Description of the Related Art Including Information Disclosed Under 37 CFR 1.97 and 1.98

Paging systems that notify customers when a desired service is available are well known. It's also known for such systems to provide additional information to service recipients who are waiting to be paged.

### BRIEF SUMMARY OF THE DISCLOSURE

A customer paging and communications system is provided that includes a base unit comprising an input interface configured to receive one of a plurality of pager identifiers, a base unit processor configured to receive pager identifiers and to generate alert signals associated with the respective pager identifiers, and a base unit transmitter configured to transmit the pager identifiers, an informational message, and an alert signal. The system also includes a plurality of pagers, each identified with a corresponding one of the pager identifiers, and each comprising a pager receiver configured to receive a pager identifier, an informational message, and an alert signal from the base unit. Each pager also includes a pager processor configured to generate an alert if a received alert signal is associated with the pager identifier associated with that particular pager, and a display configured to display the informational message. Unlike the prior art, the base unit is configured to stream information to the plurality of pagers and each pager is configured to display the streamed information. Therefore, a customer paging and communications system constructed according to the invention is better able to entertain customers awaiting service. According to another aspect of the invention, the base unit is configured to stream multimedia information (audio and video) to the plurality of pagers and each pager is configured to receive and display the streamed multimedia information.

According to another aspect of the invention, the base unit and pagers include respective video streaming transceivers configured to stream video between the base unit and the pagers.

According to another aspect of the invention, the base unit and pagers are configured for bi-directional communication with pagers (synchronizable with the streamed video).

According to another aspect of the invention, the base unit and pagers include respective bi-directional communication transceivers configured to enable bi-directional communication between the base unit and the pagers.

According to another aspect of the invention, pagers are configured for bi-directional communication between pagers.

According to another aspect of the invention, the system includes a command response network configured to provide communication between the base unit and the pagers.

According to another aspect of the invention, the system includes a mesh network configured to provide communication between the base unit and the pagers.

According to another aspect of the invention, each pager includes a touchscreen and is configured to display an interactive user interface on the touchscreen.

According to another aspect of the invention, further including a master unit configured to store information, a communications network connected between the master unit and a plurality of the base units, each base unit being configured to receive an informational message from the master unit via the communications network and to transmit the informational message to at least one of the pagers associated with each base unit.

According to another aspect of the invention, the master unit, communication network, and base unit are configured to stream information to the pagers.

According to another aspect of the invention, the master unit, communication network, and base unit are configured to stream multimedia information (audio and video) to the pagers.

According to another aspect of the invention, the master unit is configured to transmit updates to the pagers via the communication network and the base units.

According to another aspect of the invention, the master unit is configured to perform diagnostics on the pagers via the communication network and the base units.

### BRIEF DESCRIPTION OF THE SEVERAL VIEWS OF THE DRAWINGS

These and other features and advantages of the invention will become apparent to those skilled in the art in connection with the following detailed description and drawings, in which:

FIG. 1 is a block diagram of a pager of a customer paging and communications system constructed according to the invention;

FIG. 2 is a block diagram of a base unit of a customer paging and communications system constructed according to the invention;

FIG. 3 is a block diagram of a pager charger of a customer paging and communications system constructed according to the invention;

FIG. 4 is a block diagram of a three-tier pager network arranged according to the invention;

FIG. 5 is a chart showing an RF data transmission scheme arranged according to the invention

FIG. 6 is a block diagram of a pager of a customer paging and communications system constructed according to a second embodiment of the invention; and

FIG. 7 is a block diagram of a base unit of a customer paging and communications system constructed according to a second embodiment of the invention.

### DETAILED DESCRIPTION OF INVENTION EMBODIMENT(S)

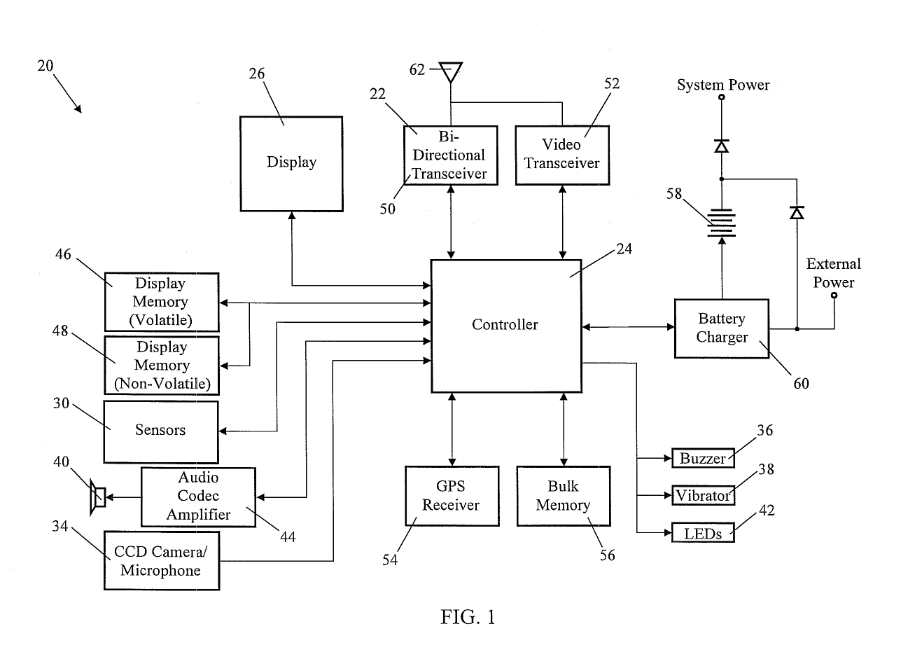

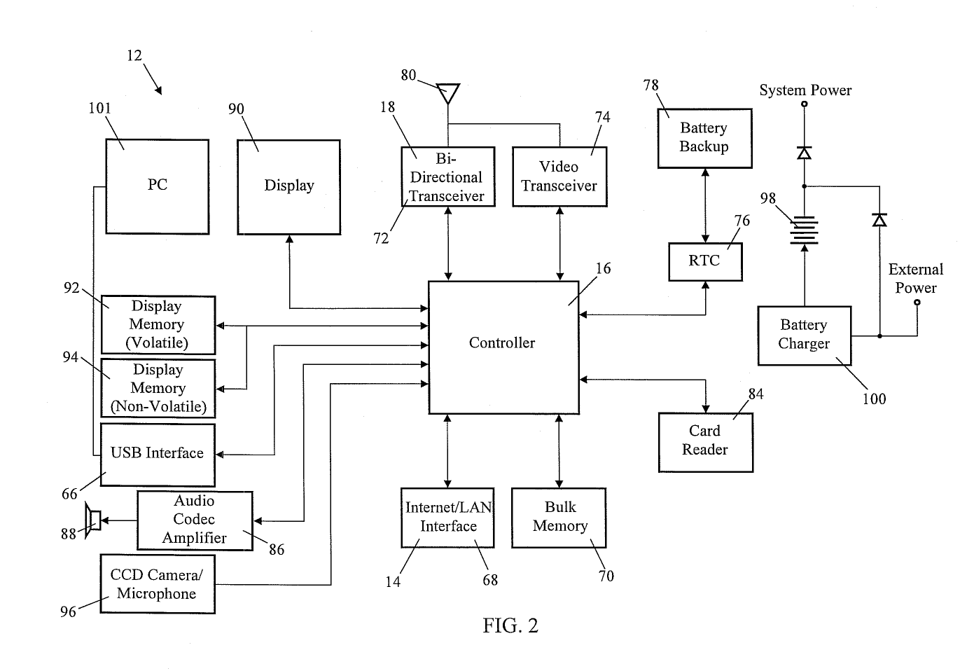

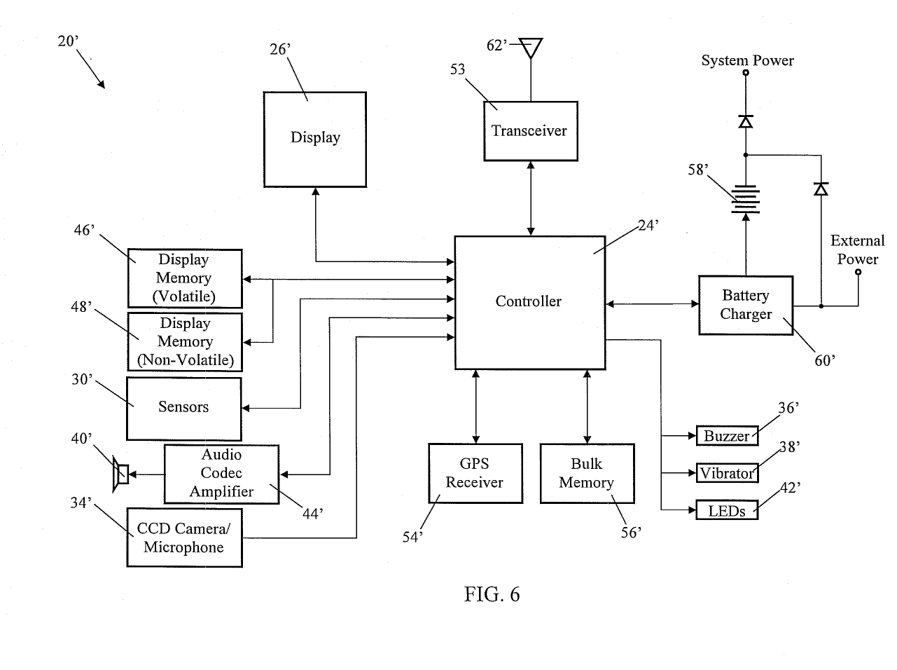

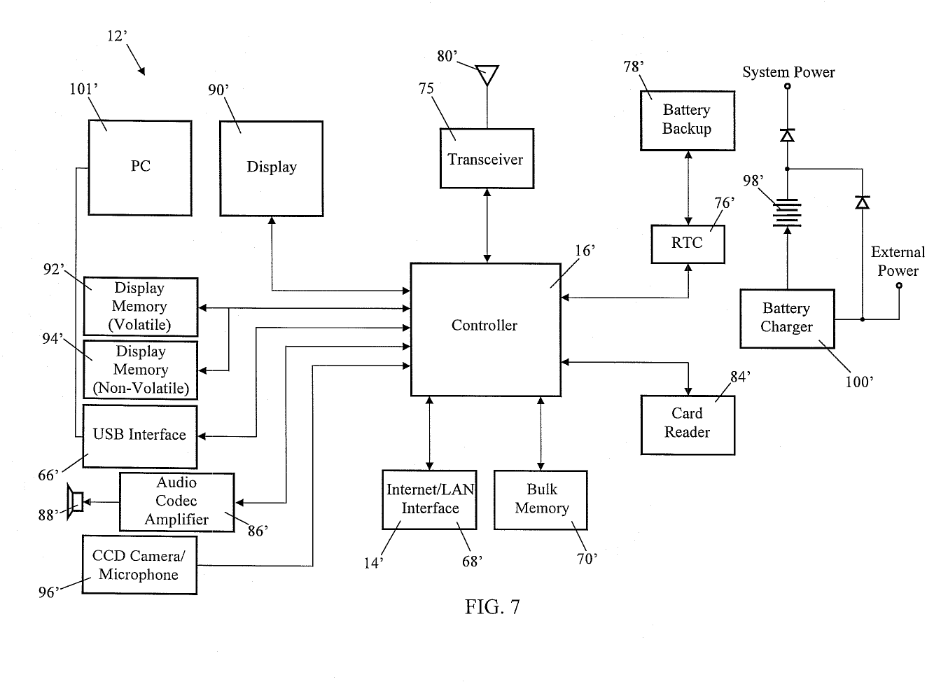

A first embodiment of a customer paging and communications system is generally shown in FIGS. 1-5 of the drawings. A second embodiment of pager and base unit components of such a system is shown in FIGS. 6 and 7. Reference numerals with the designation prime (′) in FIGS. 6 and 7 indicate alternative configurations of elements that also appear in the first embodiment. Unless indicated otherwise, where a portion of the following description uses a reference numeral to refer to FIGS. 1 and 2, that portion of the description applies equally to elements designated by primed numerals in FIGS. 6 and 7.

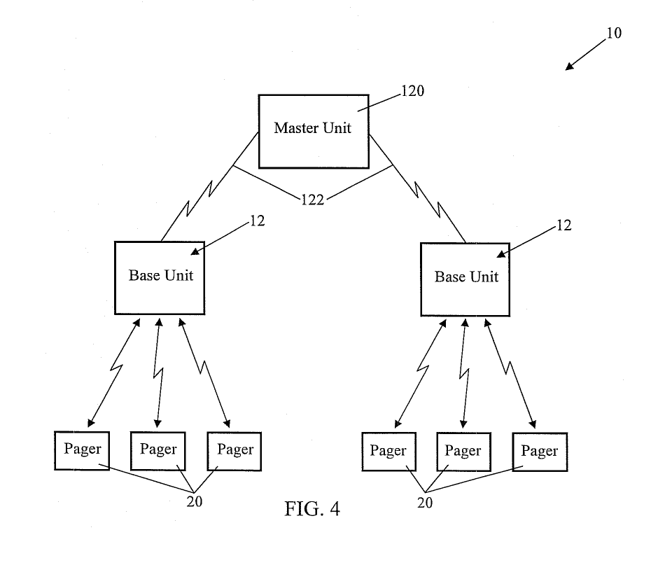

The system 10 may include one or more base units, generally indicated at 12 in FIGS. 2 and 4, each of which comprises an input interface 14 configured to receive one of a plurality of pager identifiers, a base unit processor or controller 16 that receives the pager identifiers and generates alert signals associated with the respective pager identifiers, and at least one base unit transmitter 18 that transmits the pager identifiers, an informational message, and/or an alert signal. The system 10 may also include a plurality of pagers, generally indicated at 20 in FIGS. 1 and 4, each of which may be identified with a corresponding one of the pager identifiers, and each of which may comprise at least one pager receiver 22 that receives a pager identifier, an informational message, and/or an alert signal from the base unit 12; a pager processor or controller 24 that may be programmed to generate an alert if a received alert signal is associated with the pager identifier associated with that particular pager 20; and a pager display 26 that may be configured to display the informational message.

The pager controller 24 of each pager 20 may be programmed to support simultaneous multi-level image display structure for live video feeds, POS display, and entertainment display features. As shown in FIG. 1, each pager 20 may include peripheral sensors 30 such as a 3 axis accelerometer, and/or a magneto-resistive compass. The pager controller 24 of a pager 20 may be connected to and configured to receive inputs from the peripheral sensors 30 of the pager. Each pager 20 may also include an integrated CCD camera array 34, which may have a 2 megapixel resolution capability and may also incorporate a microphone. The pager controller 24 may be connected to and configured to receive data from the CCD camera 34 and microphone. Each pager 20 may further include indicators for patron notification, such as a buzzer 36, a vibrator 38, a pager audio speaker or audio output jack 40, and/or LED indicator lights 42, and the pager controller 24 may be connected to and configured to operate the buzzer 36, vibrator 38, and LED lights 42. The pager controller 24 may also be connected to and configured to send signals to an audio CODEC amplifier 44 carried by the pager 20 and configured to output audio to the pager speaker and/or audio jack 40. Other devices that may be included in the pager 20 and connected to the pager controller 24 include the pager display 26, which may be a 65 K color ¼ VGA backlit TFT or OLED LCD touchscreen; volatile display memory 46; non-volatile display memory 48; a pager bi-directional RF transceiver 50 which may be capable of providing 16 2.4 GHz RF channels for standard bi-directional communication; a pager video stream transceiver 52 that may be capable of providing 16 RF channels for simultaneous video streaming at 30 frames/sec; a GPS receiver 54; and bulk memory 56, which may have a capacity of 20 Gigabytes or greater. The pager controller 24 may be programmed to manage interactive touchscreen user interface operations and functions such as image display control, operator input processing, point-of-sale (POS) events, and gaming. The pager controller 24 may also be programmed to manage audio and video streaming via the pager transceivers 50, 52, and may also be programmed to manage real-time image download through the pager video stream transceiver 52 via 16 channels simultaneously at a rate of 30 frames/sec, and to provide scrolling data for real-time image update along a lower margin of the pager display 26. The pager controller 24 may be programmed to sense an existing or impending out-of-range condition in response to, for example, a loss of message reception, and to then provide an out-of-range indication on the pager display 26 and/or via audio notification. Each pager 20 may also include a rechargeable pager battery 58 that may be a Lithium-Ion battery and may connected to and configured to power pager components for, e.g., up to 6 hours. A pager battery charging IC 60 may be connected between the rechargeable pager battery 58 and charging pins connectable to an external source of electrical power. The pager battery charging IC 60 may be connected to and configured to communicate with the pager controller 24 to condition electrical power received from an external power source for charging of the rechargeable pager battery 58 and to insure that charging current is applied to the rechargeable pager battery 58 only when the pager battery 58 is not fully charged. The pager controller 24 may be programmed to sense a low battery condition and to provide a low battery notification on the pager display 26 and/or via an audio notification. Each pager 20 may further include an antenna 62 connected to the pager bi-directional RF transceiver 50 and the pager video stream transceiver 52. Each pager 20 may be constructed to be of a size and weight approximating those of current industry standard pagers, and may include a housing constructed to survive a drop from a height of 3 feet to concrete. In other embodiments, and as shown in FIG. 6, the functions of the pager bi-directional RF transceiver 50 and the pager video stream transceiver 52 may be performed by a single RF transceiver 53 of suitable data bandwidth.

As shown in FIG. 2, the base unit controller 16 may be connected to a USB interface 66, an Internet/LAN interface 68 that may comprise an ethernet and/or 802.11 wi-fi interface for information download and system control via the internet, a bulk memory module 70 that may have a capacity of 20 Gigabytes or greater, a base unit bi-directional RF transceiver 72 that may be capable of providing 16 2.4 GHz RF channels for standard bi-directional communication, a base unit video stream transceiver 74 that may be capable of providing 16 RF channels for simultaneous video streaming at 30 frames/sec, and a real-time clock (RTC) 76 connected to and powerable by a battery back-up 78. The base unit controller 16 may be programmed to manage audio and video streaming via the base unit transceivers 72, 74, 74. The base unit 12 may also include an antenna 80 connected to the base unit transceivers 72, 74 and an integrated card reader 84 connected to the pager controller 24. The base unit controller 16 may also be connected and configured to send signals to a base unit audio CODEC amplifier 86 carried by the base unit 12 and configured to output audio to a base unit speaker and/or audio jack 88. The base unit 12 may also include a display 90 such as a touch-screen connected to the base unit controller 16, and the base unit controller 16 may be programmed to operate the base unit touch screen 90 as a network/system control and display interface. The touch screen 90 may be a 65 K color ¼ VGA backlit TFT or OLED LCD touchscreen, and the base unit 12 may further include volatile display memory 92 and non-volatile display memory 94 connected to the base unit controller 16. Each base unit 12 may also include an integrated base unit CCD camera array 96, which may have a 2 megapixel resolution capability and may also incorporate a microphone. The base unit controller 16 may be connected to and configured to receive data from the base unit CCD camera 96. The base unit 12 may further include a rechargeable base unit battery 98 configured to power the base unit 12 should a primary external source of electrical power fail, and a base unit battery charging IC 100 connected to the rechargeable base unit battery 98 and connectable to the external source of electrical power. The rechargeable base unit battery 98 obviates the need for a full system restart after the network has gone down by keeping all the base units 12 in the network powered-up and thus reducing the time necessary to restart the network. In other embodiments, and as shown in FIG. 7, the functions of the base unit bi-directional RF transceiver 72 and the base unit video stream transceiver 74 may be performed by a single RF transceiver 75 of suitable data bandwidth. Where the functions of the pager bi-directional RF transceiver 50 and the pager video stream transceiver 52 are also performed by a single RF transceiver 53 of suitable data bandwidth as shown in FIG. 6, communications between each pager 20 and its associated base unit 12 may be carried out via a single communication channel or RF transmission path.

Alternatively, the base unit 12 may include a PC 101 that incorporate one or more transmitters or transceivers configured to send out information to and/or receive information from the pagers 20. The base unit 12 may be connected to such a PC 101 via the USB port 66 or LAN Interface 68. The one or more transmitters or transceivers may be configured to send out and/or receive audio and video streams in a format complying with the MPEG4 standard, which, in Europe, is known as the H264 standard. However, in other embodiments the audio and video streams may be sent out in any one of a number of suitable formats known in the art.

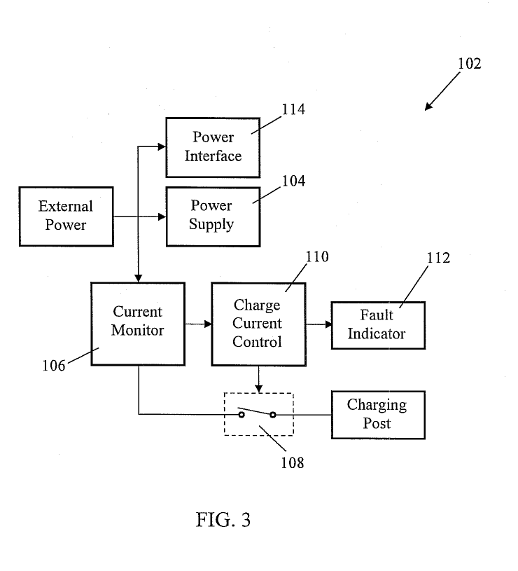

As shown in FIG. 3, the system 10 may comprise a pager charger 102 which may include a charging stand that may include, for example, 45 pager cradles, each pager cradle including two charger charging posts positioned to engage corresponding pairs of pager charging posts that may be carried by each pager 20 and that are connected to the rechargeable batteries of the respective pagers 20. The pager charger 102 may also include a power supply 104 connectable to an external power source and configured to receive power from the external power source and to provide at least 0.5 A charge current to each charging stand cradle to charge the batteries of any pagers 20 occupying the cradles. The pager charger 102 may further include a current monitor 106 connected to the power supply 104 and the external power source, and an over-current protection switch 108 connected between the current monitor 106 and one of the charger charging posts. A charge current control or over-current controller 110 may be connected to the current monitor 106 and the over-current protection switch 108 and programmed to operate the over-current protection switch 108 in response to signals received from the current monitor 106, e.g., to interrupt charge current when a charge current fault such as an over-current condition is detected. An integrated fault indicator 112 may be connected to the charge current control 110 and configured to provide a fault indication in response to signals received from the charge current control 110 indicating that a charge current fault has occurred. The pager charger 102 may also include a daisy-chain power interface 114 for systems requiring multiple battery chargers.

The base unit 12 may be capable of streaming multimedia information (audio and video) to the plurality of pagers 20 and each pager 20 may be capable of receiving and displaying the streamed multimedia information. The video streaming transceiver 74 of the base unit 12 may be configured to stream video/audio (broadcast form) between the base unit 12 and the pagers 20.

The base unit 12 and pagers 20 may be capable of bi-directional communication with pagers 20. The bi-directional communication may be synchronized with the streamed video. The respective bi-directional communication transceivers 72, 50 of the base units 12 and pagers 20 may be used to enable bi-directional communication between the base unit 12 and the pagers 20. The pagers 20 may also be capable of enabling bi-directional communication between themselves. The base unit and pager bi-directional communication transceivers 72, 50 may operate in the RF band. However, in other embodiments, these bi-directional communications transceivers 72, 50 may use any suitable signal transmission medium known in the art.

The system 10 may, therefore, be configured to move information along two different information conduits. A video streaming conduit may carry video information between each base unit 12 and its associated pagers 20, and a bi-directional communication conduit may be used to carry communications back and forth between the base units 12 and their associated pagers 20. The two information conduits may be implemented by the two transceivers 50, 52 in each pager 20 and the two transceivers 72, 74 in each base unit 12. The video stream transceiver 74 (72), 52 in each base unit 12 and each pager 20 may be operated as video stream transceivers for video streaming, and the bi-directional RF transceivers 72, 50 in each base unit 12 and each pager 20 may be used for bi-directional communications (although the video stream transceivers 74, 52 also operate in the RF band).

The bi-directional communication conduit may be used to allow customers to place orders with service providers operating the base units. For example, where the service provider is a restaurant, a customer can scroll through many different menu items displayed on the customer's assigned pager, and select a menu item causing the pager 20 to transmit an order from the pager 20 to the restaurant's base unit 12. This would allow a customer to order goods and services that are either offered by the service provider for immediate delivery to the customer, or are available from a third party advertiser.

The system 10 may be configured to stream audio and video data, real time, to pagers 20 so that customers can see it and hear it as it's being sent. To accomplish this, the system 10 may be configured to have a large amount of processing power and a very fast RF link such as may be provided by incorporating a chipset from a Nomadik family of chipsets (e.g., P/N STn8815) available from ST Microelectronics (formerly SGS Thompson) of Geneva Switzerland. Such a real-time bi-directional communication conduit would allow customers near a common base unit 12 to communicate with one another in real time and/or to engage in interactive activities, such as gaming, that require real-time communication.

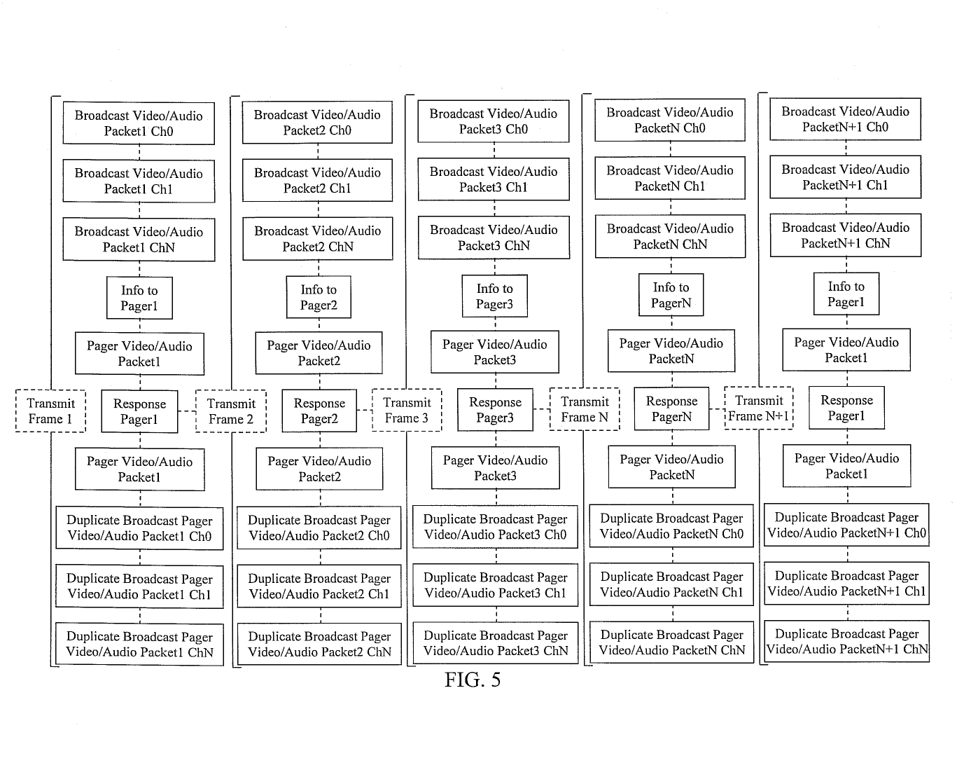

As shown in FIG. 5, the pager controller 24 and transceivers 50, 52 and the base unit controller 16 and transceivers 72, 74 may be configured to execute an RF data transmission scheme that includes a transmission bit stream comprising an audio/video packet, an information packet, a response packet, and a pager audio/video packet. According to the scheme, a base unit controller 16 may be programmed to command base unit transceivers 72, 74 to send real time video/audio, in multiple channels, contained within the audio-video packet. The base unit controller 16 may be further programmed to command its transceivers 72, 74 to send audio/video packets more than once during each transmit frame to avoid data loss that might otherwise result from interference and/or range issues associated with RF communications. Accordingly, the base unit 12 may send each audio/video packet at least twice during each transmit frame. In other words, each audio/video packet, per channel, may be sent at least twice. The base unit controller 16 may further be programmed to command its transceivers 72, 74 to execute a number of transmission retries that varies dependent upon the number of video channels that are being transmitted. In other words, if only two video channels are being broadcast, the number of retries per channel may be, for example, 16. If four video channels are being broadcast, the number of retries per channel may be, for example, four.

Each information packet sent by the base unit 12 may be unique to a specific pager. This information may be used to instruct the pager controller 24 of a specific pager 20 what needs to be done during a given operation. The data/instructions that the base unit 12 sends to the pagers 20 may be encoded by a binary message. A minimum of 2̂16 message types may be sent to the pager.

The pager controllers 24 may be programmed to command their respective pager transceivers 50, 52 to send response packets in response to information packets received from a base unit 12. Each such response packet may include information regarding the diagnostic health of the sending pager, what a user carrying the pager 20 would like to order (in, for example, a restaurant application), the position of the pager 20 as determined by, for example, data received from the GPS receiver, payment information, and/or generic encrypted data related to, for example, gambling applications, etc.

The pager audio/video packet may include real time video/audio sent between the base unit 12 and a pager 20 after being received by a pager camera 34 and/or microphone and/or a camera and/or microphone connected to the base unit 12. This data may or may not be duplicated, as in the base unit's video/audio stream. Base unit and pager controllers 16, 24 may be programmed to use this data to provide a two-way audio and/or video phone for closed loop communication between a patron operating a pager 20 and a host operating a base unit 12, or between two patrons operating respective pagers 20.

Data in the audio/video packet may include compressed MPEG4/H264 data and may further include an accompanying stereo audio stream, such as MP3. The data that is transmitted may be buffered by the base unit 12 and may be queued for transmission based upon a software scheduler. The scheduler may be configured to allow for data to be transmitted at specific times during the day/night for billing purposes in, for example, the case of advertisements.

The system 10 may also include wireless point-of-sale (WPOS) capability to allow a customer to pay for goods or services the customer has ordered from a base unit-operating service provider or from a third party advertiser. The base units 12 may be configured to record charges incurred by customers of service providers through use of pagers 20 associated with each base unit 12 and assigned to the customers. Each base unit 12 may be configured to receive and store credit card information via the card reader 84 for each customer of the service provider that is operating that base unit 12, to associate each customer's credit card information with the pager 20 each customer is using, and to automatically assign and bill charges incurred by customers using pagers 20. Accordingly, each time a customer orders something via the customer's assigned pager, the base unit 12 will recognize the corresponding signals as having originated from that customer's pager 20 and will add the charges associated with the order to that customer's bill. Once the customer turns-in the customer's assigned pager, the customers charges may all be billed automatically to the customer's credit account.

The system 10 may be configured for command response or “round robin” communications between base units 12 and pagers 20. In other words, the base units 12 may be configured to communicate with a single associated pager 20 at a time in sequence, forming a command response network. For example, if there are 3 pagers 20 active, the base unit 12 will transmit information to a first one of the pagers 20 and receive information back, and will then transmit information to a second of the pagers 20 and receive information back from the second pager, will then transmit information to the third pager 20 and receive information back, and then return to the first pager. The system 10 may also be configured for base units 12 to broadcast universally applicable information to all pagers 20 associated with those base units 12. Broadcast information may include, for example, a specific command for all pagers 20 to display to customers a single message.

In addition, while the system 10 may operate on a command response or round robin basis from the base units 12 to their associated pagers 20, the system 10 may also be configured to operate on a “response on change” basis. In other words, the pagers 20 may also have the ability to send a command in a short unit of time to notify the base unit 12 that the pager's status has changed in some way. The status of a pager 20 may change because the customer carrying that pager 20 orders something or has moved or is moving out of range, or because the pager's battery is low on power. The system 10 may also be configured for “collision detection” so that if, for example two pagers 20 transmit information simultaneously to the base unit 12 and the base unit 12 fails to register one or both of the transmissions, the pagers 20 will resend those transmissions in response to not having received an acknowledgment from the base unit 12.

The system 10 may also, or may alternatively, include a mesh network that provides communication between the base unit 12 and the pagers 20. The mesh network may be enabled by the pager and/or base unit controllers 24, 16 and transceivers 50, 52, 72, 74, with the pager and/or base unit controllers 24, 16 being programmed to command the pager and/or base unit transceivers 50, 52, 70, 74 to transmit information on the bi-directional communication conduit in such a way that pagers 20 associated with each base unit 12 relay signals between one another and the base unit 12.

Each pager 20 may also be programmed to save power by automatically limiting signal transmission power. The automatic limitation on transmission power may be based on feedback from the associated base unit 12 or, in a mesh network, from other pagers 20 in the mesh network, which are receiving those transmissions. In other words, pager transceivers' output power may be controlled automatically in response to signals received from the base unit 12 (or from another pager 20 in a mesh network) indicating incoming signal strength from the pager 20 whose output power is to be adjusted. A receiving base unit 12 or pager controller 24 may, therefore, be programmed to command that a signal be sent back to the transmitting pager 20 indicating to the transmitting pager's controller 24 that the received signal strength is weak. In response, the transmitting pager controller 24 may be programmed to increase the transmission power of one or both of its transceivers 50, 52 in accordance with the signal from the receiving base unit 12 or pager.

For example, where the system 10 includes a mesh network, a first pager 20 may happen to be exchanging data with a base unit 12 using a second pager 20 as an intermediary to relay signals. If, while transmitting data, the intermediary pager 20 starts to lose signals it's been receiving from the first pager, the intermediary pager 20 may be configured to pass off the role of intermediary to another pager 20 and/or signal the first pager 20 to increase its power output as long as necessary for another pager 20 to take over as intermediary.

Pagers 20 in a mesh network may thus be programmed to be sensitive to each other's power output requirements, and may also be programmed to notify other transmitting pagers 20 when those other pagers 20 need to increase their power output. The result would be a dramatic reduction in power use rates and commensurate increases in the length of time between rechargeable pager battery 58 recharges. Such arrangements would save power and increase rechargeable pager battery life by allowing pagers 20 to transmit at minimum power levels at all times, i.e. at power levels that are just high enough to insure that information is accurately and rapidly transmitted.

The system 10 may be configured to further limit pager power consumption by programming the pagers 20 to normally operate at a very low level of power use and to then kick up to a higher power level whenever it's necessary to receive and transmit. Where the system 10 includes a mesh network that inherently experiences system delays due to the time it takes to transmit information through a number of peers to get the information to the base unit 12, each pager 20 may include an override that either automatically or in response to operator input, kicks the transmit power up high enough to communicate directly with the base unit 12, eliminating any mesh network transmission delay.

Alternatively, or in addition, the system 10 may include software control of base unit 12 and/or pager transceiver 50, 52 signal strength. Software control may be used to control the output power and, therefore, the range of individual pagers 20 and/or overall system range. The target range of the system 10 may be 3000 feet from transmitter (LOS). One or more of the pagers 20 may be configured to allow a user such as a restaurant customer to adjust the output power of the pager 20 assigned to the user, through an interface such as the touch screen user interface. Alternatively, or in addition, a service provider may limit the transmitter output power of one or more pagers 20 and/or the base unit 12 to limit the range from the service provider's base unit 12 at which customers are able to use the pagers 20, or to avoid interfering with neighboring pager networks.

The pagers 20 and a base unit 12 may be configured to use their respective CCD camera/microphones and transceivers 50, 52, 70, 74 to provide two-way visual and/or audio communication between a restaurant hostess, for example, and pager-toting customers. Customers could also use the CCD camera/microphones and bi-directional pager transceivers 50, 52 to communicate with each other.

As shown in FIG. 4, the system 10 may further include a master unit 120 that may be configured to store, transmit, and receive information, and may further include a communications network 122, such as a cell network or the internet, connecting the master unit 120 to a plurality of the base units 12. Each base unit 12 may be capable of receiving an informational message from the master unit 120 via the communications network 122 and of transmitting the informational message to at least one of the pagers 20 associated with each base unit 12, thus forming a three-tier paging system 10. The master unit 120, communication network 122, and base unit 12 may also be capable of streaming multimedia information (audio and/or video) to the pagers 20. The master unit 120 may also be capable of transmitting updates to the pagers 20 via the communication network 122 and the base units 12 and of performing diagnostics on the pagers 20 via the communication network 122 and the base units 12.

As is best shown in FIG. 4, the invention may therefore comprise a three-tier pager system 10 in which the master unit 120 may be operated by a paging system provider and may be linked up with a plurality of the base units 12 via the communications network 122, with the base units 12 being located at respective service provider's establishments. This three-tier arrangement allows the paging system provider and/or service providers (such as restaurants) to sell advertisements to third party advertisers, obtain advertising content from the third party advertisers, then download that content from the master unit 120 via the communications network 122 to the base units 12 located with respective service providers, and then transmit the advertising content from the base units 12 directly out to pagers 20 associated with those base units 12. In other words, it's a system or process capable of enabling remote paging system providers and/or local service providers to deliver information to the service providers' customers.

The system 10 may be configured to allow 16 channels of multi media to be streamed simultaneously to individual pagers 20. The multi-media streaming may originate at either the base units 12 or at the master unit 120. The display screen 26 of each pager 20, which, as indicated above, may comprise an LCD screen or any other suitable display technology, may be divided into 16 blocks or regions, allowing customers to watch 16 different video channels at once, i.e., 16 different video images on a single LCD display of a single pager. Alternatively, the system 10 may be configured to allow a customer to tab between screens to select between the video images provided by the 16 channels. For example, if a customer wanted to see what was being cooked in a restaurant at which the customer was awaiting a table, the customer could tab to a channel that is streaming video images of what the cook is cooking at that moment. Or, if a customer wanted to watch a sports channel, the customer could click to a channel displaying programming from a sports channel being streamed from the base unit 12 or from the master unit 120 via the base unit 12. If a customer wanted to see an advertising channel, the customer could click to a channel displaying programming from an advertising channel being streamed from the base unit 12 or from the master unit 120 via the base unit 12 to the customer's pager. To watch CNN, the customer clicks to a channel displaying streamed CNN programming relayed from CNN through the master unit 120 and the base unit 12 to the customer's pager. The base unit 12 may be configured to stream 16 channels of potentially high definition video information simultaneously to each pager 20 associated with the base unit 12. A customer could configure his pager 20 to display all 16 channels at once, or could select fewer channels or just a single channel for viewing.

The video streaming capability of the system 10 may provide, through the video streaming conduit, the ability to deliver to customers advertising content, web content, or television shows that are either in progress or have been recorded for later viewing. The two-way communication provided by the bi-directional communication conduit allows customers to use their pagers 20 as, for example, video poker machines, with information being transferred back and forth over a secure network.

The system 10 may also include differential GPS capability which, instead of providing accuracy of 20 to 50 feet, would allow the location of pagers 20 to be determined to within a few centimeters. This feature allows lost or stolen pagers 20 to be located, and allows wait staff, for example, to locate customers who have placed drink orders—wherever those customers might be. In other words, after a customer has selected a drink or food item from a menu on the touchscreen of the customer's assigned pager, the GPS capability allows the customer to be located and the order delivered to the customer regardless of where the customer may have wandered.

The system 10 may also be configured for remote site system control, which allows a paging service operator to remotely control pager networks for a number of different service providers. The system 10 may thus be configured to allow a paging service operator to download information to, upload information from, and/or run diagnostics on each base unit 12 and its associated pagers 20 for each of the service providers—all from a remote location such as the paging service operator's place of business or central office. Remote site system 10 control may be accomplished via any suitable communications network such as the internet or a cell network, and may be used to accomplish such tasks as initial configuration and system 10 set-up, system 10 updates, system 10 debug, information download, billing, integrated POS features, gaming control, and security control.

One application for the system 10 is for use by golfers. Golfers at a golf tournament could carry the pagers 20 and wear earphones to listen to an audio stream of what's going on elsewhere at the tournament, or could select between audio video streams from different locations, e.g., from each hole being played. The live audio video streams could be fed from the cameras and microphones of a television network or other provider of audio and videography services. The audio and video feeds may be sent into a base unit transmitter 18 which, in turn, would send out this information to pagers 20 associated with that base unit 12.

Another application for the system 10 is for use by visitors at a zoo. As mentioned above, each pager 20 may include a GPS receiver. For use at a zoo, each pager 20 may be programmed to track its own movements and to automatically switch to whatever channel provides information about whatever location the pager 20 is in at the moment. Users could override the automatic function to check the status of animals at other locations in the zoo, e.g., if the visitor wanted to check and see whether a certain animal was still sleeping or inactive, the visitor could override the automatic system 10 and select the video stream from the location of that animal.

Another application for the system 10 is for use by customers at an amusement park. Customers may use the system 10 to put themselves on wait lists for certain rides, shows, restaurants or other attractions by selecting a number of such attractions on their assigned pagers 20. A base unit 12 located at the park would track customers' places on the wait lists or in the lines for the various attractions at the park and notify each customer a requested number of minutes in advance of an estimated time when each customer will be at the head of the lines for each attraction.

A customer paging and communication system constructed according to the invention is capable of providing master unit remote site system control over multiple systems to include remote billing, changing of applications, diagnosing of faults, etc. Multiple video streaming paths provide the ability to switch between “channels” on the fly, and the ability to have repeated data in the video stream to ensure that the video stream is maintained, i.e., not choppy/broken due to missing video frames. Wireless point of sale billing is also made possible through the use of a pager, providing ease and accuracy of billing applicable to almost any function or purpose for which the system may be used. Such a system is also capable of providing two-way communication between customers and between customers and base unit operators/service providers, and provides for the extension of pager battery life through pager unit output power control regardless of which networking scheme is employed.

This description, rather than describing limitations of an invention, only illustrates embodiments of the invention recited in the claims. The language of this description is therefore exclusively descriptive and is non-limiting. Obviously, it's possible to modify this invention from what the description teaches. Within the scope of the claims, one may practice the invention other than as described above.

What is claimed is:

1. A customer paging and communications system comprising:
a base unit comprising an input interface configured to receive one of a plurality of pager identifiers, a base unit processor configured to receive pager identifiers and to generate alert signals associated with the respective pager identifiers, and a base unit transmitter configured to transmit the pager identifiers, an informational message, and an alert signal; and
a plurality of pagers, each identified with a corresponding one of the pager identifiers, and each comprising:
a pager receiver configured to receive a pager identifier, an informational message, and an alert signal from the base unit;
a pager processor configured to generate an alert if a received alert signal is associated with the pager identifier associated with that particular pager; and
a display configured to display the informational message;
the base unit being further configured to stream information to the plurality of pagers and each pager being further configured to display the streamed information.

2. A customer paging and communications system as defined in claim 1 in which the base unit is configured to stream multimedia information (audio and video) to the plurality of pagers and each pager is configured to receive and display the streamed multimedia information.

3. A customer paging and communications system as defined in claim 2 in which the base unit and pagers include respective video streaming transceivers configured to stream video between the base unit and the pagers.

4. A customer paging and communications system as defined in claim 1 in which the base unit and pagers are configured for bi-directional communication with pagers.

5. A customer paging and communications system as defined in claim 4 in which the base unit and pagers include respective bi-directional communication transceivers configured to enable bi-directional communication between the base unit and the pagers.

6. A customer paging and communications system as defined in claim 4 in which pagers are configured for bi-directional communication between pagers.

7. A customer paging and communications system as defined in claim 1 in which the system includes a command response network configured to provide communication between the base unit and the pagers.

8. A customer paging and communications system as defined in claim 1 in which the system includes a mesh network configured to provide communication between the base unit and the pagers.

9. A customer paging and communications system as defined in claim 1 in which each pager includes a touchscreen and is configured to display an interactive user interface on the touchscreen.

10. A customer paging and communications system as defined in claim 1 further including:
a master unit configured to store information,
a communications network connected between the master unit and a plurality of the base units,
each base unit being configured to receive an informational message from the master unit via the communications network and to transmit the informational message to at least one of the pagers associated with each base unit.

11. A customer paging and communications system as defined in claim 10 in which the master unit, communication network, and base unit are configured to stream information to the pagers.

12. A customer paging and communications system as defined in claim 11 in which the master unit, communication network, and base unit are configured to stream multimedia information (audio and video) to the pagers.

13. A customer paging and communications system as defined in claim 10 in which the master unit is configured to transmit updates to the pagers via the communication network and the base units.

14. A customer paging and communications system as defined in claim 10 in which the master unit is configured to perform diagnostics on the pagers via the communication network and the base units.
